(19) United States
(12) Patent Application Publication
(10) Pub. No.: US 2015/0035280 A1
(43) Pub. Date: Feb. 5, 2015

(54) DEVICE FOR THE ADJUSTMENT AND STABILIZATION OF WIND TURBINES

(71) Applicant: Nelson G. Paul, Morrisville, NC (US)

(72) Inventor: Nelson G. Paul, Morrisville, NC (US)

(21) Appl. No.: 13/956,516

(22) Filed: Aug. 1, 2013

(51) Int. Cl. F03D 7/02; F03D 9/00

(52) U.S. Cl. CPC F03D 7/0204; F03D 9/002
USPC 290/44; 290/55

(57) ABSTRACT

This invention pertains to a device by which electrical wind turbine generators are aligned to the wind by means of a wheel or wheels operated by electrical or hydraulic power, said wheel or wheels being in contact with the ground. The present invention also increases the stability of electrical wind turbine generators by providing additional support to the wind turbine structure against the force of the wind.

### FIELD OF THE INVENTION

The present invention allows the automatic adjustment of electrical wind turbine generators by means of a wheel or wheels in contact with the ground and turned by electrical or hydraulic power. The present invention also increases the stability of electrical wind turbine generators by using the wheel or wheels in contact with the ground to oppose the force of the wind.

### BACKGROUND OF THE INVENTION

Modern electrical wind turbine generators typically consist of a generator and blades held in a framework atop a vertical pole, stand or tower. Typically, this framework is designed to rotate in a circle in a horizontal plane so as to present the best possible exposure of the generator blades to the current wind or for whatever affects the operator desires.

Present art dictates that wind turbines obtain their support from static structures. These structures generally consist of poles or towers supported by guy wires, self-supported stands, or monopole towers. The framework holding the generator and blades typically rotates on a bearing at the top of the pole, stand or tower. This framework is oriented to the wind by everything from simple wind vanes to computerized gear drives. Typically the framework is supported entirely by a bearing or bearings located at the top of the vertical pole, stand or tower.

Prior art consists of a historical windmill variant commonly referred to as the “post mill”. The post mill design is approximately 400 years old and was widely used prior to the industrial age. Post mills consist of a vertical post (hence the name) that served as the point of rotation, around which was constructed a framework or “buck” that housed the mill machinery. On one side of the buck, the blades would be positioned, and extending out the opposite end of the buck would be a long shaft or post known as the “tailpole”.

The operator would either push or pull on the side of the tailpole, or hook up an animal, to rotate the buck in a circle around the post. The addition of a wheel to end of the tail post, or “tailwheel”, helped support the weight of the buck and made the rotation activity easier for the operator. Historical records indicate tailwheel designs ranged from wooden wagon wheels resting on the ground surface to small iron casters designed to run around circular iron (railroad like) tracks.

Attempts at automating the alignment of the ancient post mill blades relative to the wind by mechanical means were not very successful. This was due to the massive weight of the post mill buck and machinery. One notable device, however, enjoyed a measure of success. This was a primitive but sophisticated wind-operated machine known as a “tailfan”.

The tailfan consisted of a second wind driven device similar to the primary blades of the windmill. The tailfan was attached directly over the tailwheel and differed significantly from the primary blades of the windmill in that it was installed perpendicular to the primary blades of the windmill and presented only an edge to the preferred wind direction. When the wind shifted from one direction to another, the angle increased so that more and more of the tailfan blade area would be exposed. When the critical force on the tailfan was achieved, the tailfan would rotate. When the tailfan rotated it would drive a series of chains and/or gears that would move the tailwheel, and hence the entire windmill, in the necessary direction.

A study of the historical record indicates this is the only methodology for powering tailwheels in a windmill application. Post mills were used to grind grain, saw timber, and pump water; activities that were better suited to steam engines and electrical motors once they became available. Because of this, post mills became obsolete with the advent of the Industrial Age. Application of the tailpole/tailwheel from the historical post mill to the modern electrical wind turbine generator has been seriously neglected and/or overlooked.

Other historical devices of note include the first known electric wind turbine generator constructed by Charles F. Brush, Sr. in Cleveland, Ohio. This wind turbine rotated around a central post and included supports that extended perpendicularly downward that terminated in small cast iron wheels. These wheels ran in a circle on an iron track around the central pivot point of the wind turbine. A directional wind vane adjusted the device relative to the wind. The wheels differ from the present invention in that the wheels were free spinning and not powered.

Prior art indicates the intermittent application of similar wheels and tracks. Of note, the “Windmill Tower”, (U.S. Pat. No. 4,323,331, Schachle, et. al. Apr. 6, 1982) consists of a tower that rotates around a central point with free spinning casters on tracks similar to the Brush model. Additionally, the “Pivoting Structural Cellular Wall for Wind Energy Generation”, (Patent No. US 2012/0114501 A1, Rutherford, May 10, 2012) uses the same system of casters on tracks as Brush and Schachle. All of these devices are adjusted using the natural directional forces of the wind.

Modern electrical wind turbine generators are either adjusted automatically using the natural directional forces of the wind or adjusted by gear mechanisms that interact closely between the nacelle and tower.

### SUMMARY OF THE INVENTION

It is the object of the current invention is to deploy a modern electrical wind turbine generator that incorporates the tailpost/tailwheel design. Powering the tailwheel provides a new method by which a wind turbine can be oriented to the wind. In addition, the tailwheel provides stabilization and support to the wind turbine by opposing the force of the wind.

The exact apparatus configuration providing for such an effect may best be seen by the detailed description of the preferred embodiment as follows.

### BRIEF DESCRIPTION OF THE DRAWINGS

Referring now to the drawings, FIG. 1 represents a conceptual electrical wind turbine generator (1) in oblique view. This concept consists of framework (2) that houses the electrical generator and supports the wind turbine blades (9). The framework is supported by the post (3), upon which the framework (2) rotates around in a circle (16) horizontally. Attached to the framework (2), is a tailpole (5), comprised of a pole, shaft or other structure extending perpendicularly and horizontally outward and downward from the framework (2). To the end of the tailpole (5) is attached a tailwheel (4). The tailwheel (4) driven by a motor (7) through a gearbox (6) and is capable of powering the tailwheel in either direction. The tailwheel motor is regulated by a wind vane (8) and, in so doing, keeps the generator blades (9) oriented with the wind direction (10).

FIG. 2 presents the conceptual electrical wind turbine generator (1) in profile view showing the framework (2); the post supporting the framework (3); tailwheel (4); tailpole (5); motor (7); gearbox (6); generator blades (9); and wind vane (8). Additional detail is provided regarding the main framework bearing (11), the post shaft (12), the pivot bearing (13) and beams supporting the framework (14).

FIG. 3 shows the conceptual electrical wind turbine generator (1) in plan view showing the framework (2); the tailwheel (4); tailpole (5); motor (7); gearbox (6); generator blades (9); and wind vane (8). Additional detail is provided regarding the main framework bearing (11), the post shaft (12), the pivot bearing (13), and beams supporting the framework (14).

### DETAILED DESCRIPTION OF THE PREFERRED EMBODIMENT AND SPECIFICATIONS

Referring again to the Figures, a conceptual electrical wind turbine generator (1) is presented. This concept consists of framework (2) that houses the electrical generator and provides support for the turbine blades (9). The framework is supported by the post (3), upon which the framework (2) rotates horizontally around in a circle (16). Attached to the framework (2) is the tailpole (5), comprised of a shaft extending perpendicularly and horizontally outward and downward from the framework (2). On the end of the tailpole (5) is attached a tailwheel (4) driven by a reversible motor (7), through a gearbox (6), which powers the tailwheel (4). Applying power to turn the tailwheel (4) selectively allows the wheel (4), shaft (5) and turbine framework (2) to rotate in either direction (16). The wind vane (8) regulates the power being transmitted to the tailwheel, and in so doing, keeps the generator blades (9) oriented into the wind (10).

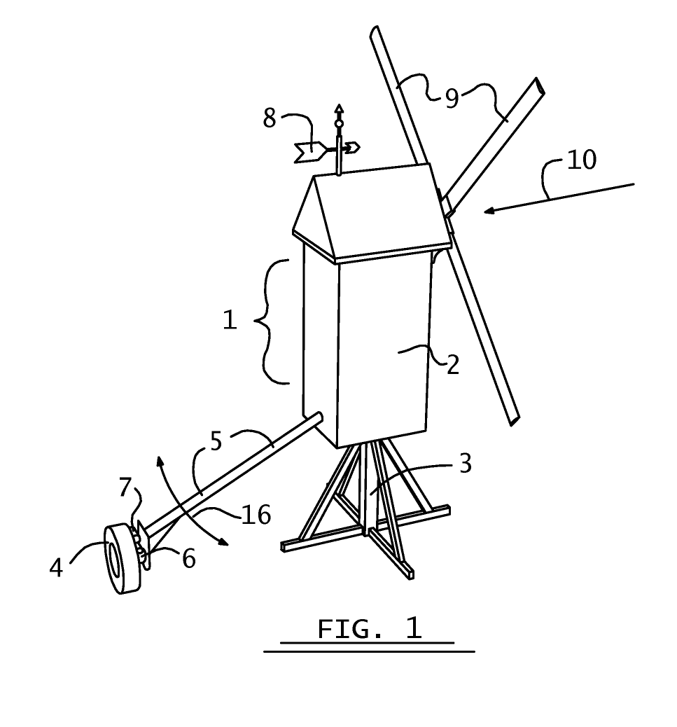

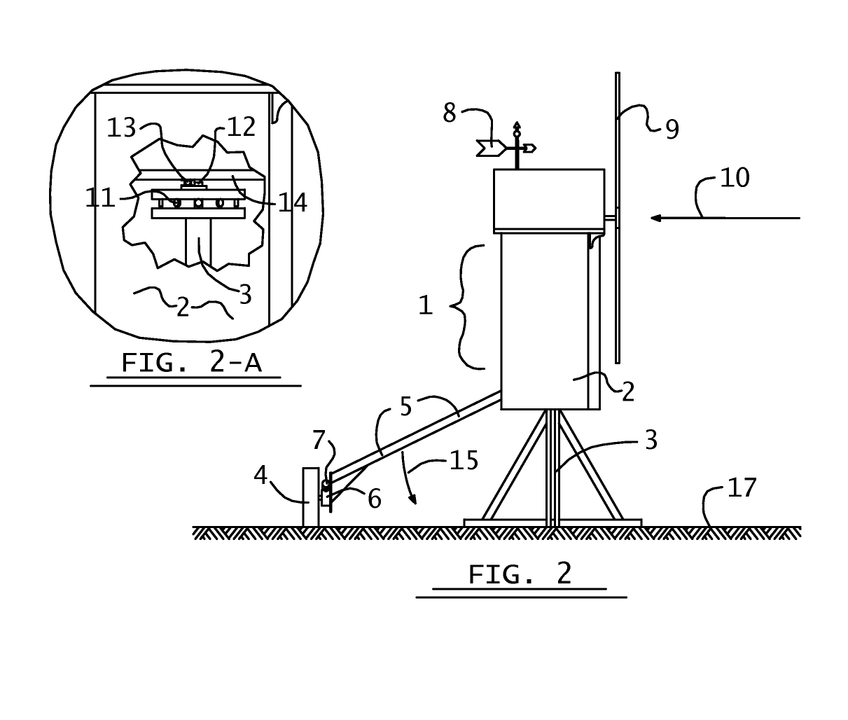

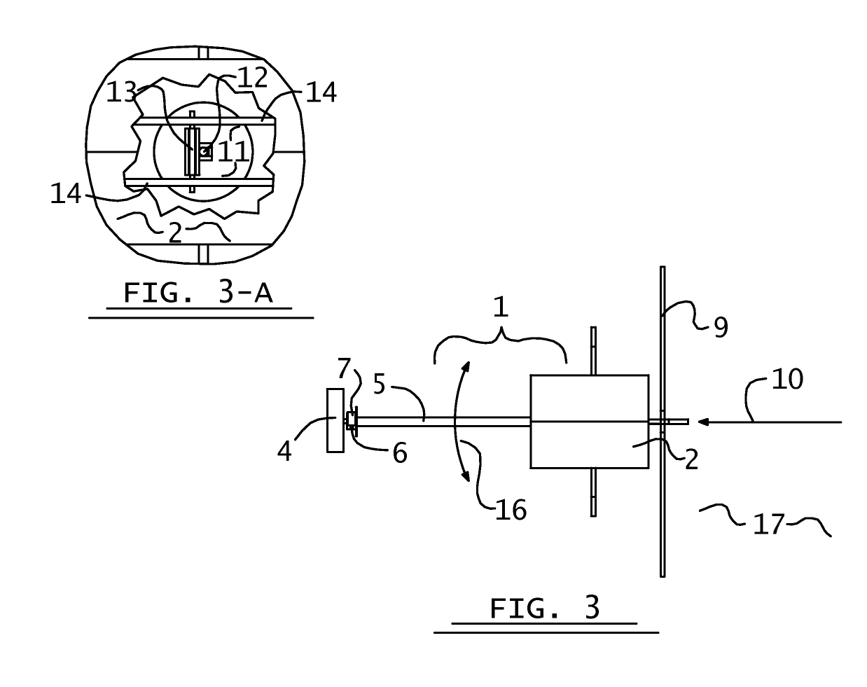

The Figures also present the some additional functions and operations of the conceptual wind turbine (1). Referring to FIG. 2 specifically, oriented into the wind, the wind force (10) presses against the turbine blades (9) and framework (2) causing the framework to rotate slightly on the pivot bearing (13) and transfer the force downward (15). This energy is absorbed by the tailpole (5) and tailwheel (4), the tailwheel being in contact with the ground (17). FIG. 3 further illustrates the mechanisms involved in rotating the framework (2) and in transferring this force (10) to the tailwheel (4), and ultimately, the ground (17).

It is also within this concept that hydraulic pressure can be used to power an hydraulic motor (7) to turn the tailwheel.

It should be apparent to those skilled in the field that within the general description given, a wide range of embodiments is possible while still encompassing the basic features and improvements of the current invention and thus the invention is not restricted to those specific embodiments described but rather the wider range of equivalents encompassed by the claims below:

1. An electrical wind turbine generator comprised of a nacelle, buck, house or other framework holding an electrical generator and supporting the generator blades;
Said framework being supported by a post, tower, stand, or other supporting structure, around which the framework is able to freely rotate horizontally in a circular motion;
From said framework, extending perpendicularly and horizontally outward and downward is a pole, shaft or other structure;
Attached to the end of said pole, shaft or other structure, is a wheel, or plurality of wheels;
Said wheel, or plurality of wheels, being in contact with the ground surface; and,
Said wheel, or plurality of wheels, being turned by electrical or hydraulic means to cause the framework containing the electrical generator and generator blades to rotate in a circular motion horizontally around the post, tower, stand or other supporting structure.

2. An electrical wind turbine generator as described in claim 1, where said wheel, or plurality of wheels, are controlled by a mechanism to adjust the orientation of the framework containing the wind turbine generator and generator blades to a specific position relative to the wind direction.

3. An electrical wind turbine generator as described in claim 2, where said wheel, or plurality of wheels, adds stability and support by providing an opposing force to the wind.
